(19) United States
(12) Patent Application Publication
(10) Pub. No.: US 2012/0039165 A1
(43) Pub. Date: Feb. 16, 2012

(54) Network Interface

(76) Inventors: Andrew Brown, Houston, TX (US); David F. Heinrich, Tomball, TX (US)

(21) Appl. No.: 13/263,776

(22) PCT Filed: Apr. 28, 2009
(86) PCT No.: PCT/US09/41941

§ 371 Date: Oct. 10, 2011

(51) Int. Cl. H04L 12/26

(52) U.S. Cl. 370/220

(57) ABSTRACT

A network interface includes a first port configured for communicatively coupling to a first interface for selectively passing communication signals between the first interface and a processor communicatively coupled to the network interface; a second port configured for communicatively coupling to a second interface for selectively passing communication signals between the second interface and the processor; and a controller configured to, independently of the processor, switch communications from between the first interface and the processor to between the second interface and the processor in response to detecting a failure of communications through the first port.

### BACKGROUND

Typically, fallover and/or redundancy in a network environment in which there are multiple network interfaces involves an operating system and/or a network interface driver running on a computer system. The operating system and/or the network interface driver typically routes communications through a selected interface via a network interface by addressing a selected port of a selected network interface. The operating system and/or the network interface driver may monitor the communications to detect any loss of communications through the selected interface, if the operating system and/or network interface driver detects a loss of communications through the selected interface, the operating system and/or network interface driver may reroute the communications through another interface by addressing another port of a network interface. The monitoring and rerouting of communications by the operating system and/or the network interface driver consumes valuable system resources of the computer system.

### BRIEF DESCRIPTION OF THE DRAWINGS

FIG. 1 is a block diagram illustrating one embodiment of an automatic failover and/or redundancy system for a network.

FIG. 2 is a block diagram illustrating one embodiment of a network interface.

FIG. 3 is a flow diagram illustrating one embodiment of a method for performing automatic failover and/or redundancy in a network.

FIG. 4 is a block diagram illustrating one embodiment of a system including automatic failover and/or redundancy.

### DETAILED DESCRIPTION

In the following detailed description, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

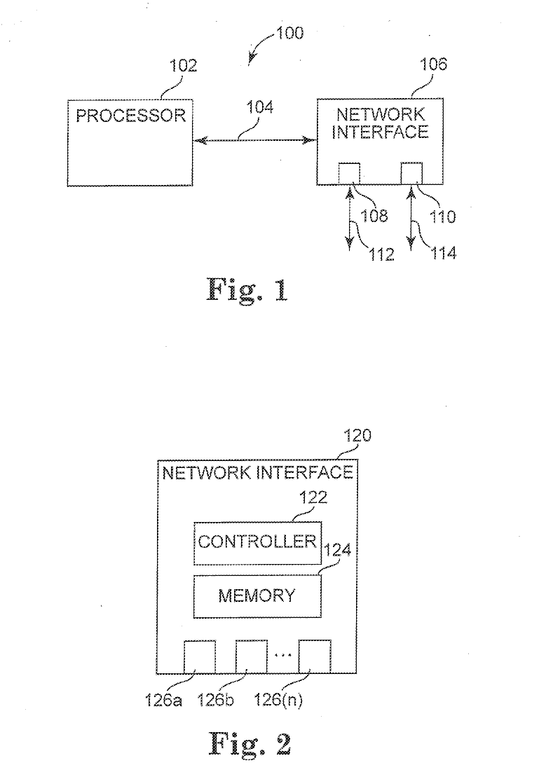

FIG. 1 is a block diagram illustrating one embodiment of an automatic failover and/or redundancy system 100 for a network. System 100 includes a processor 102 and a network interface 106. In one embodiment, network interface 106 includes a first port 108 and a second port 110. Processor 102 is communicatively coupled to network interface 106 through communication link 104. Network interface 106 is communicatively coupled to a first interface 112 through first port 108. In one embodiment, first interface 112 is an Ethernet interface and first port 108 is an Ethernet port. Network interface 106, is communicatively coupled to a second interface 114 through second port 110. In one embodiment, second interface 114 is an Ethernet interface and second port. 110 is an Ethernet port. Network interface 106 provides automatic failover and/or redundancy for communications with processor 102. In response to network interface 106 detecting a failure of communications through one of first interface 112 and second interface 114, network interface 106 automatically reroutes communications through the other of first interface 112 and second interface 114 independently of processor 102.

In one embodiment, processor 102 is part of a server, a personal computer (PC), or another suitable device configured for transmitting and/or receiving communications through a network, in one embodiment, communication link 104 is a peripheral component interconnect (PCI) bus, a PCI express bus, a sideband interface, a universal serial bus (USB), or another suitable communication link. In one embodiment, network interface 106 is a network card, a network adaptor, a network interface controller (NIC), a network interface card, a local area network (LAN) adaptor, a USB hub, or another suitable network interface. In one embodiment, first port 108 of network interface 106 is assigned a first address and second port 110 of network interface 110 is assigned a second address.

Processor 102 selectively transmits and receives communications through first interface 112 by addressing first port 108 of network interface 106.

Processor 102 selectively transmits and receives communications through second interface 114 by addressing second port 110 of network interface 106, in one embodiment, just one of first port 108 and second port 110 is active at a time. Therefore, processor 102 transmits and receives communications through one of first interface 112 and second interface 114 at a time via the active port.

Network interface 106 monitors the communications with processor 102 via the active port. In response to network interface 106 detecting a loss of communications through the active port, network interface 106 automatically switches the routing of communications through the other port independently of processor 102. For-example, if processor 102 is communicating with first interface 112 through first port 108, network interface 106 monitors the communications through first port 108 to detect a failure of communications. In response to network interface 106 detecting a failure of communications through, first port 108, network interface 106 automatically reroutes the communications to second interface 114 through second port 110 independently of processor 102.

In one embodiment, network interface 106 automatically reroutes communications by reassigning the first address first port 108 to second port 110 by switching the first address of first port 108 with the second address of second port 110. Therefore, processor 102 continues to address the same port of network interface 106; however the communications are automatically rerouted through second pert 110 rather than first port 108. Processor 102 is not involved with the rerouting of the communications nor aware of the rerouting of the communications performed by network controller 106. In one embodiment, network interface 106 transmits a message to processor 102 after rerouting the communications to inform processor 102 of the rerouting.

In one embodiment, network interface 106 detects a failure of communications by detecting a loss of link or a loss of the electrical connection between first port 108 and first interface 112 or between second port 110 and second interface 114. In another embodiment, network interface 106 detects a failure of communications by detecting a loss of valid internet protocol (IP) packets for a set period. In another embodiment, network interface 106 detects a failure of communications by periodically attempting to perform a ping or another suitable test to a known ‘echo’ server. If a response is not received in response to the ping or test, network interface 106 detects a failure of communications. In another embodiment, network interface 106 detects a failure of communications by detecting a failure of a link layer discovery protocol (LLDP). In another embodiment, network interface 106 detects a failure of communications by detecting a preset number of collisions for a set period. In other embodiments, network interface 106 detects a failure of communications using, other suitable techniques.

FIG. 2 is a block diagram illustrating one embodiment of a network interface 120. In one embodiment, network interface 120 provides network interface 106 previously described and illustrated with reference to FIG. 1 Network interface, 120 includes a controller 122, a memory 124, and a suitable number of ports 126a-126(n). Controller 122 includes a microprocessor, microcontroller, or other suitable logic circuitry for controlling network interface 120. Memory 124 includes a non-volatile memory, such as a read only memory (ROM), an electrically erasable and programmable read only memory (EEPROM), a flash memory, or another suitable memory. In one embodiment, memory 124 stores firmware executed by controller 122 to control network interface 120.

Each port 126a-126(n) of network interface 120 is configured for selectively communicating with an interface communicatively coupled to each port. In one embodiment each port 126a-126(n) is assigned a unique address that is stored in memory 124. Controller 122 monitors communications through an active port 126a-126(n). In response to detecting a failure of communications though an active port 126a-126(n), controller 122 automatically switches the unique address of the active port experiencing the loss of communications with the unique address of another port. Thereafter, the communications are automatically rerouted through the other port without the knowledge or control of the device communicating through network interface 120.

For example in one embodiment, network interface 120 is assigned a unique media access control (MAC) address and each port 126a-126(n) is assigned a unique media-independent interface (MN) or reduced media independent interface (RMII) address. The addresses are stored in memory 124. In response to controller 122 detecting a loss of communications through an active one of ports 126a-126(n), controller 122 automatically switches the MII or RMII address of the port experiencing the loss of communications with the MII or RMII address of another port. The switchover is transparent to any external device routing communications through network device 120 since the MAC address remains the same. In addition, in one embodiment, virtual local area network (VLAN) tagging is also maintained.

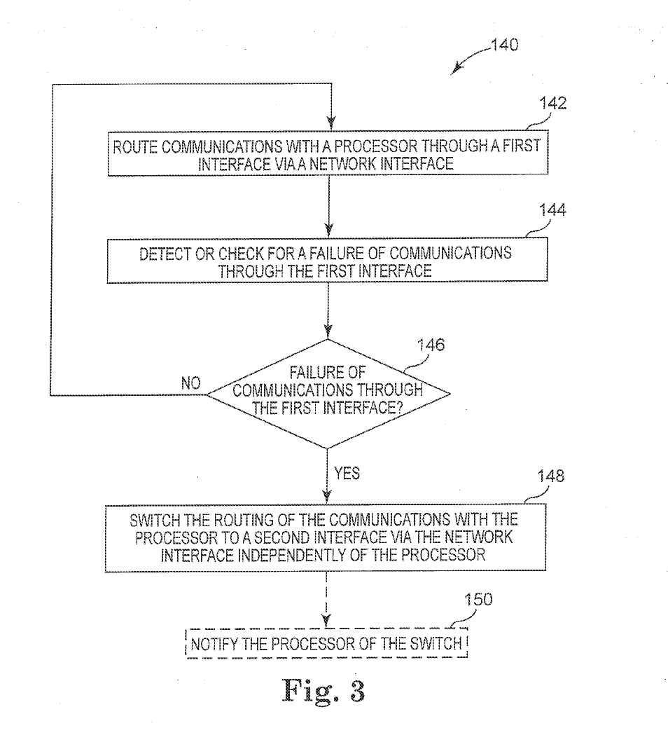

FIG. 3 is a flow diagram illustrating one embodiment of a method 140 for performing automatic failover and/or redundancy in a network. At 142, communications with a processor are routed through a network interface to a first interface. At 144, the communications through the first interface are monitored to detect or check for a failure of the communications. At 146, if there is no failure of communications through the first interface, the communications with the processor are continued to be routed through the first interface network interface at 142. If at 146 there is a failure of communications through the first interface, then at 148 the network interface, independently of the processor, switches the routing of the communications with the processor to a second interface. In one embodiment, the network interface notifies the processor of the switch in routing at 150. In other embodiments, the network interface does not notify the processor and the processor remains unaware of the switch in routing.

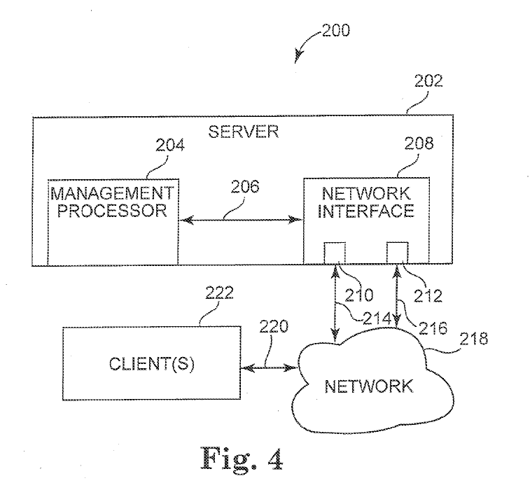

FIG. 4 is a block diagram illustrating one embodiment of a system 200 including automatic failover and/or redundancy. System 200 includes a server 202, a network 218, and one or more clients 222. Server 202 includes a management processor 204, a network interface 208, and other suitable components (not shown) such as a main processor, memory, additional network interfaces, etc. Network interface 208 includes a first port 210 and a second port 212. Management processor 204 is communicatively coupled to network interface 208 through communication link 206. First port 210 communicatively couples network interface 208 to network 218 through first interface 214. Second port 212 communicatively couples network interface 208 to network 218 through second interface 216. Network 218 is communicatively coupled to one or more clients 222 through communication link 220. Network 218 includes any suitable number of interconnected switches, hubs, bridges, repeaters, routers, and/or other suitable network devices.

In one embodiment, server 202 is configured for being remotely managed by a client 222 via management processor 204. Management processor 204 is communicatively coupled to a client 222 through network interface 208 and network 218. Network interface 208 is configured for automatically rerouting communications with management processor 204 through one of first interface 214 and second interface 216 in response to detecting a failure of communications through the other of first interface 214 and second interface 216. In this way communications between management processor 204 and a client 222 are maintained seamlessly by network interface 208 independently of management processor 204.

The failure of communications could be due to a failure within network interface 208 itself, such as a failure of first port 210 or second port 212. The failure of communications could also be due to a failure of first interface 214 or second interface 216, such as a broken cable. The failure of communications could also be due to a failure within network 218, such as a failed switch, hub, bridge, repeater, router, cable, etc. In any case, network interface 208 provides automatic failover and/or redundancy by detecting the failure of communications and by rerouting the communications in response to detecting the failure.

Embodiments provide a network interface for providing automatic failover and/or redundancy. Embodiments of the network interface transparently maintain communications between devices communicatively coupled through the network interface independently of the communicating devices. Automatic failover and/or redundancy is provided by embodiments of the network interface without consuming system resources of the devices communicating through the network interface.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A network interface comprising:
a first port configured for communicatively coupling to a first interface for selectively passing communication signals between the first interface and a processor communicatively coupled to the network interface;
a second port configured for communicatively coupling to a second interface for selectively passing communication signals between the second interface and the processor; and
a controller configured to, independently of the processor, switch communications from between the first interface and the processor to between the second interface and the processor in response to detecting a failure of communications through the first port.

2. The network interface of claim 1, wherein the processor addresses the first port with a first address and the second port with a second address, and wherein the controller is configured to switch the first address and the second address in response to detecting a failure of communications through the first port.

3. The network interface of claim 1, wherein the controller is configured to detect a failure of communications through the first port by one of detecting a loss of link, detecting a loss of valid packets for a set period, detecting a preset number of collisions for a set period, detecting a failure of a link layer discovery protocol, and detecting a failure to perform a ping.

4. The network interface of claim 1, wherein the first port comprises a first Ethernet port and wherein the second port comprises a second Ethernet port.

5. The network interface of claim 1, wherein the processor comprises a management processor for remotely managing a server.

6. A network interface comprising:
means for communicatively coupling a processor to a first interface for selectively passing communication signals between the processor and the first interface;
means for communicatively coupling the processor to a second interface for selectively passing communication signals between the processor and the second interface; and
means for, independently of the processor, switching communications from between the processor and the first interface to between the processor and the second interface in response to detecting a failure of communications through the means for communicatively coupling the processor to the first interface.

7. The network interface of claim 6, wherein the first interface comprises a first Ethernet interface and wherein the second interface comprises a second Ethernet interface.

8. The network interface of claim 6, further comprising:
means for communicatively coupling the processor to a third interface for selectively passing communication signals between the processor and the third interface.

9. The network interface of claim 6, wherein the network interface comprises one of a network card, a network adaptor, a network interface controller, a network interface card, a local area network adaptor, and a universal serial bus hub.

10. The network interface of claim 6, further comprising:
means for informing the processor of the switch in communications to the second interface.

11. A method for passing communication signals through a network, the method comprising:
communicatively coupling a processor to a first interface to pass communication signals between the processor and the first interface based on an address provided by the processor;
detecting a failure of communications between the processor and the first interface independently of the processor; and
communicatively coupling the processor to a second interface independently of the processor to pass communication signals between the processor and the second interface in response to detecting the failure.

12. The method of claim 11, wherein detecting the failure comprises one of detecting a loss of link, detecting a loss of valid packets for a set period, detecting a preset number of collisions for a set period, detecting a failure of a link layer discovery protocol, and detecting a failure to perform a ping.

13. The method of claim 11, further comprising:
informing the processor of the failure of communications between the processor and the first interface.

14. The method of claim 11, wherein communicatively coupling the processor to the first interface comprises communicatively coupling the processor to the first interface based on a media access control (MAC) address, and
wherein communicatively coupling the processor to the second interface comprises communicatively coupling the processor to the second interface without changing the MAC address.

15. The method of claim 14, wherein communicatively coupling the processor to the second interface comprises communicatively coupling the processor to the second interface by switching a first address of the first interface with a second address of the second interface.
